(19) United States
(12) Patent Application Publication
(10) Pub. No.: US 2020/0058032 A1
(43) Pub. Date: Feb. 20, 2020

(54) Biometric Payment Transaction Without Mobile or Card

(71) Applicants: Denikumar Dalpatbhai Lad, Ahmedabad (IN); Vivek Ramdas Pandit, Mississauga (CA)

(72) Inventors: Denikumar Dalpatbhai Lad, Ahmedabad (IN); Vivek Ramdas Pandit, Mississauga (CA)

(73) Assignees: Denikumar Dalpatbhai Lad, Ahmedabad (IN); Vivek Ramdas Pandit, Mississauga (CA)

(21) Appl. No.: 16/172,820

(22) Filed: Oct. 28, 2018

(30) Foreign Application Priority Data
Aug. 20, 2018 (CA) 3015041
Aug. 25, 2018 (IN) 201821031880

(51) Int. Cl. G06Q 20/40; G06Q 20/20; G06K 9/00; G06F 21/31

(52) U.S. Cl. CPC G06Q 20/40145; G06Q 20/206; G06F 21/316; G06K 9/00617; G06K 9/00288; G06K 9/00087

(57) ABSTRACT

A payment gateway/processor or system for POS/ATM/Vending Machine/any capable of device, which allows and process transactions using biometric data without use of mobile/cards/wallets by authorized biometric data. Financial institution while issuing accounts (by registering customer using biometric) also assigned virtual biometric account/credit cards and system may process a transaction with captured biometric information only to identify virtual account associated against stored biometric information comply with it. A Payment transaction does not require any physical payment card or any sort of current mode of transaction information. A payment gateway system will authorized the merchant payment from customer's account using stored biometric data while issued/registered from issuer financial institution. If it conflict against the stored biometric information, it may decline the transaction. The customer's biometric (all 10 finger-print) and palm (Left and Right) information or behavioral information stored in Bank/Financial Institute server/Cloud server.

### CROSS-REFERENCE TO RELATED APPLICATIONS

### U.S. Patent Documents

U.S. Pat. No. 9,916,432 Storing and retrieving cryptographic keys from biometric data
U.S. Pat. No. 9,141,951 Electronic transaction verification system with biometric
U.S. Pat. No. 8,403,213 Time analysis at a banking system controlled by data bearing records
U.S. Pat. No. 7,614,551 Method and system for securely encoding and decoding biometric data into a memory device using a two dimensional symbol
U.S. Pat. No. 10,049,673 Synthesized voice authentication engine
U.S. Pat. No. 8,725,579 Device ID and financial information
U.S. Pat. No. 8,370,262 System and method for performing secure online transactions
U.S. Pat. No. 9,984,360 Processing payment transactions without a secure element
U.S. Pat. No. 9,972,005 Cloud-based transactions methods and systems
U.S. Pat. No. 9,898,728 System and method for one-time payment authorization in a portable communication device
U.S. Pat. No. 9,775,029 Embedding cloud-based functionalities in a communication device
U.S. Pat. No. 9,241,238 Wireless communication system and wireless communication method
U.S. Pat. No. 9,047,601 Method and apparatus for settling payments using mobile devices
U.S. Pat. No. 9,978,064 Hosted thin-client interface in a payment authorization system
U.S. Pat. No. 9,972,047 Systems and methods for performing a purchase transaction using rewards points
U.S. Pat. No. 8,682,791 Redemption of credit card rewards at a point of sale
U.S. Pat. No. 9,940,612 Fraud detection in portable payment readers
U.S. Pat. No. 9,846,875 Electronic transaction verification system with biometric authentication
U.S. Pat. No. 9,177,314 Method of making secure electronic payments using communications devices and biometric data
U.S. Pat. No. 9,165,323 Biometric transaction system and method
U.S. Pat. No. 8,407,142 Managing a universal payment account
U.S. Pat. No. 7,631,193 Tokenless identification system for authorization of electronic transactions and electronic transmissions
U.S. Pat. No. 7,620,605 System and method for processing tokenless biometric electronic transmissions using an electronic rule module clearinghouse
U.S. Pat. No. 6,615,191 Software licensing and distribution systems and methods employing biometric sample authentication

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

With various embodiments' background of this invention, includes information that may be useful in understanding the present invention.

It is not an admission that any of the information provided herein is prior art or relevant to the presently claimed invention, or that any publication specifically or implicitly referenced is prior art.

A payment gateway/processor for POS/ATM/Vending Machine/any capable of device, which allows and process transactions using biometric data without use of mobile/cards/wallets by authorized biometric data. Financial institution while issuing accounts (by registering customer using biometric) also assigned virtual biometric account/credit cards to process a transaction. A Payment transaction does not require any physical payment card or any sort of current mode of transaction information.

A payment gateway system will authorized the merchant payment from customer's account using stored biometric data while issued/registered from issuer financial institution. The customer's biometric (all 10 finger-print) and palm (Left and Right) information stored in Bank/Financial Institute server/Cloud server.

The payment switch will route payment transaction from captured biometric information (encrypted data) by using any capable of device to identify an account. This biometric data will be encrypted using security device and in sort of standard existing security biometric encryption algorithm. Routed message will be sent to card management server under the issuer bank/financial institution using payment method and further interface to host banking or third-parties like VISA/MASTERCARD/AMEX/Diners/etc.

Bank or issuer financial system will authorized the payment transaction using captured biometric information against account registered with biometric stored data. In the event of any unauthorized payment transaction against the verification of biometric data registered on issuer server while such discrepancy found against captured such encrypted information using device from transaction decrypted message information.

### FIELD OF THE INVENTION

The scope of this invention; just using touch to pay.

This is Biometric Payment Solution for the modern edge and digital revolution in fintech industry. Today there are more solutions introduced for the digital payments and claiming the security in the different aspects. Most of them are mobile based solution. As mobile is become a part of everyone's life, more mobile solutions are introduced. However Biometric Payment Method (an innovation) is opening all new way to look at the payment solutions.

This solution gives an access to pay anything and everything on your fingertips. One can pay his/her grocery bill by touching biometric touch pad. No Card or Mobile or any other medium is required. All you need is your fingers.

This is most secure way to pay at shop, roam freely around without wallet or mobile. Without fear of identity theft or card stolen or lost. This innovation will give you a freedom to pay by using your fingers. No one else can pay without you or behalf of you; not even your wife.

While carrying cash, cards, mobile devices, or digital wallet are associated with payment methods for merchant transaction or ATM transaction while travelling, communicating under any purchases, transportation or outing, where expenses or small grocery purchases can be made using.

For security of such items while taking services to authorized the permission of securing account information are necessary regardless when far from home and find a convenient way, even to forget such item or steal. So fintech system will require at least one to initiate such kind of services to purchase and unable to use such.

In the example, A person driving car and stopped by; while his friend met, excited to see and move around nearby restaurant; while taking break and relaxing with friend, car has been locked by mistake as key inside, however realised while paying the bill. In such kind of scenario by touch to pay using biometric will be effective.

In another example, Husband are on the way to pick up his wife from airport very early in the morning, as it was unexpected plan to come back, as she has changed her plan. While husband was unaware and got a call to pick up from airport; he drives the car, while he has noticed that gas/petrol is about to finish and drives his car on gas station/petrol or diesel pump. He realize that he does not carry anything, nor even mobile. Touch to pay is the option in such a scenario.

### OBJECTIVE

The main purpose of this invention in fintech industry to secure customer and bank data while a payment transaction(even small grocery transaction) will be processing without carrying mobile, wallet, mobile wallet, any type of debit or credit cards account products based on biometric data. It reduces the cost of issuing physical cards for financial institution or bank; and its biggest advantage.

### BRIEF SUMMARY OF THE INVENTION

A payment gateway processor using point of sale device to initiate the transaction by using biometric information with random generation of 2 or 3 finger combination or single finger scan data to identify the associated account stored against the bank issued Virtual PAN with biometric information without using credit or debit cards or mobile devices.

A payment transaction does not contained or required standard card information to complete the transaction; just by using biometric information. Gateway will expect to process the transaction using encrypted payment request message. Encrypted message/data will use the biometric captured data (using biometric devices) to approve the transaction against stored biometric data in the issuer server/cloud server.

A transaction can be identified using captured biometric information comparison and decline transaction if it differs. In different type of embodiments, the processor may transmit captured biometric data to identify accounts from encrypted message format. Received/Captured biometric data using security devices (can be used any of exist encryption algorithm method) against stored biometric data in respect to Virtual PAN (primary account number). The Virtual PAN/account may have domain restriction controls based on date and time of the transaction, an amount, or a merchant and device registered.

The processor may receive a payment cryptogram including the transaction details with encrypted biometric data whereas same cryptogram message can be decrypted under same algorithm method (encrypted while captured)which can be used from current running payment transaction or biometric system. The device system may take input from on board instruction by customer/merchant to further route the message for required message communication information using standard message protocol such as ISO8583, ISO20022 etc. along with captured biometric data to authenticate using 2 or 3 finger combination scan (random generation combination) or single finger scan to validate against the stored biometric data against same identification of finger print.

The biometric data can be captured under behavioral scan algorithm as issued while registered such account with issuer on various compatible technique. The payment invention system must register customer biometric 10 fingerprint scan characteristics using order with left and right hand as L1, L2, L3, L4, L5, R6, R7, R8, R9, R10 sequence and issue a virtual PAN for credit or debit mode which is digitally stored. Also palm (Left and Right) scan data to be registered and stored for same while conflict of message data to use second factor authentication. The validation data used to verify a payment message against the random 2 or 3 finger combination or single finger included with left and right finger numbering information in the message against the stored 10 finger biometric data accordance with same numbering left and right combination data received.

The payment system may use two-factor verification by palm (Left or Right) scan authentication or PIN/password which has been issued same in response to the stored biometric data while conflict of finger scans data.

The forgoing element and enhancement or feature of invention may be combined in various combinations without exclusivity, unless expressly indicated herein otherwise and under the security standard compliances like PCI-DSS, PA DSS etc. These elements and enhancements or features of invention as well as the operation of the disclosed embodiments will be under the criteria defined by national payment system under listed rules of each specified country. Also these elements and enhancements or features of invention as well as the operation of the disclosed embodiments will become more apparent as per the following description and attached charts and drawings.

The purpose of this invention to overcome the fees charging by bank to the merchant and customer; and direct credit of the goods purchase amount to the merchant's account. The biggest advantage of this invention for bank is to reduce the cost of generating/issuing physical cards and secured data.

### BRIEF DESCRIPTION OF SEVERAL VIEWS OF THE DRAWING(S)

These subject and other features, aspects, and advantages of the present invention will become better understood when the following detailed description is read with reference to the accompanying drawings in which representation of characteristics like parts throughout the diagram, wherein:

FIG. 1 illustrates the identification of finger using Left and Right numbering as well as palm scan left or right. The identification number would be sent along with message for validating against the specific finger.

FIG. 2 illustrates a detailed high level design method for a payment settlement transaction which processes using biometric authentication of virtual PAN to complete transaction without use of card or mobile or digital wallet, with various embodiments of the invention.

The process describes for enrolling biometric information at Bank/Financial Institution using biometric device, which stores biometric data in secured issuing bank server or cloud server of the financial institution, and issued virtual PAN (Personal Account Number)/account.

By using biometric device, control the process using secured device, to encrypt data by initiating any type(s) of transaction without physical card to capture biometric data request message only.

A payment processing switch will process transaction using secured device connected for encryption to capture payment message and sends to process at bank to verify details against the stored data.

Upon successful verification of biometric authorization or finger(s) scan match, replying approval message from issuing bank server to initiated device.

FIG. 3 illustrates with block diagram of a complete payment gateway process to authenticate payment transaction using captured data using any capable of device such as ATM/POS/Vending machine without card or mobile or digital wallet and validate against stored biometric virtual PAN, with various embodiments of the invention; and

FIG. 4 illustrates complete detail flow diagram of payment communication process based on biometrics, palm, biometric passcodes or PIN (personal identification number), with various embodiments of the invention which described in detail description.

FIG. 4A, illustrates merchant setup process for his Credit Settlement Account/Direct Deposit of the goods purchase amount before initiate the transaction on the secure Biometric/Merchant device (using the Secured Biometrics Authorization Process) for the customer to make the payment of the goods purchase.

FIG. 5 illustrates the characteristics of further identified and considered for future under such various embodiments represent as same.

### DETAILED DESCRIPTION OF THE INVENTION

The detailed specification herein is presented for purposes of illustration only and not to the any limitation. Thus, the detailed specification of various embodiments herein makes reference to the accompanying representation of drawings, flow diagrams and pictures, which show various embodiments by way of illustration. While these various embodiments are described with sufficient detail to enable those technical skilled in the art to practice the disclosure, it should be understood that other embodiments may be realized and that logical and mechanical changes may be made without outstating from the spirit and scope of the disclosure. For e.g, the steps recited in any of the method or process specification may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The stored biometric information may be used by a virtual account system to identify and/or authenticate a person associated with a transaction virtual PAN using a biometric device. As used herein, “stored fingerprint”, “stored palm scan”, or other behavioural and similar phrases may include a digital illustration and/or other illustration of biometric or palm data. A stored data may identify features, edges, dimensions, and other information used to identify the biometric behavioural or physiological such as palm, facial, retinal, fingerprint, vocal, handwriting, gesture, or other biometric information of an individual.

The present disclosure includes processes, methods, and electronic fintech payment products for completing transactions using a virtual PAN associated with biometrics, PIN, and/or palm scan information to identify the registered account holder. The systems may authorize and/or unauthorized transactions based in part on authentication biometric data known to the issued virtual PAN holder. In the event of identifying risk transaction, second factor authentication require such as a PIN/password, or palm data. Transactions may include all types of bank transaction, any point of sale transaction, bill-payment or purchase, rewards or loyalty point's transaction or any request services by visiting bank branch and all type of ATM transactions unless otherwise mentioned but not limited, or otherwise making changes or payments related to a transaction account. The systems may also approve and/or decline transactions based in part on biometric data inherent to the account holder such as palm scan, facial recognition, fingerprints, voice recognition and/or retinal scans. As such, customer holding account may transact without needing credit card, debit card, or mobile device, digital wallet or wallet containing an account number.

As used herein, “exactly match” or “associated with” or similar phrases may include an identical match, a partial match, meeting certain criteria, matching a subset of data, a correlation, satisfying certain criteria, a correspondence, an association, an algorithmic relationship and/or the like. For example, a first stored information may match a second stored in response to the captured information being sufficiently similar to imply the biometric data of each registered is likely from the same customer or person, even though the source from which the stored registered information are generated may not be exactly identical. Similarly, as used herein, “authenticate” or similar terms may include an exact authentication, a partial authentication, authenticating a subset of data, a correspondence, satisfying certain criteria, an association, an algorithmic relationship and/or the like.

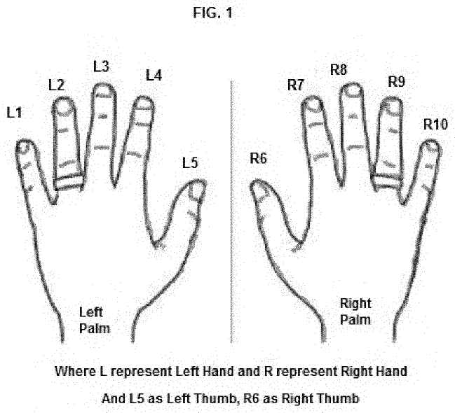

With reference to FIG. 1, A payment system generate the random number combination of finger illustrated as L1, L2, L3, L4, L5, R6, R7, R8, R9, R10 where L5 and R6 represent the thumb of left and right respectively. Where identification of number for biometric finger data has been captured will be stored into communication message to validate against same identification of finger verification.

Also, in case of conflict of data has been found in such cases the second factor authentication requires by using the (left or right) palm scan or biometric password or PIN against stored virtual PAN while issued.

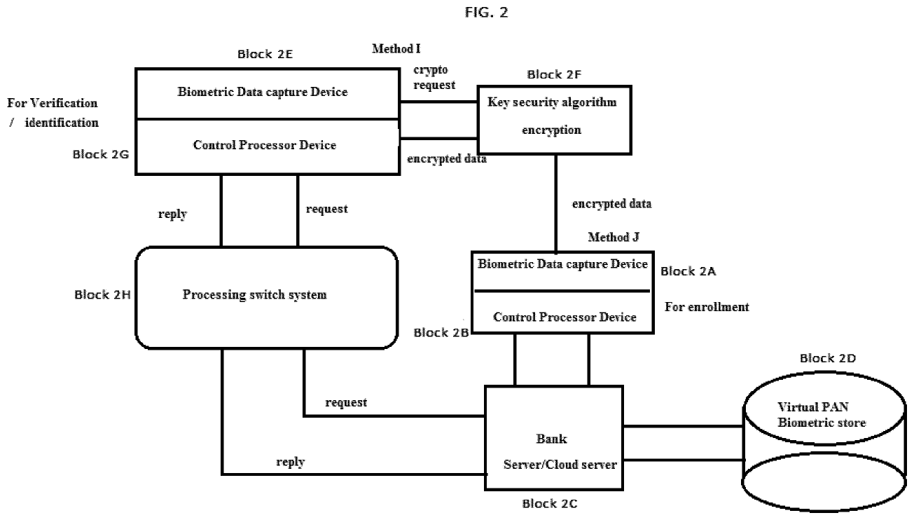

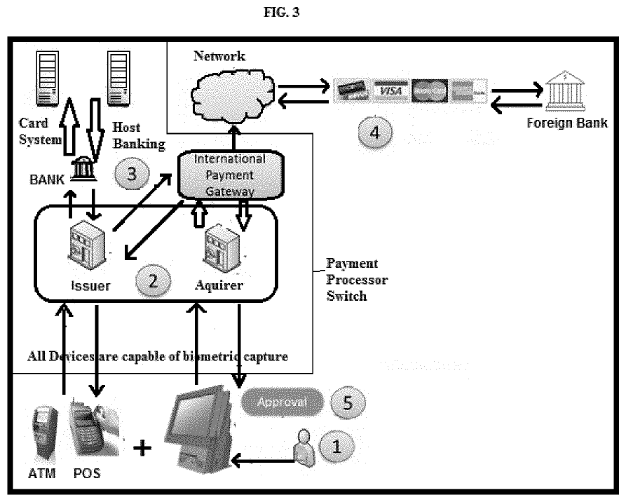

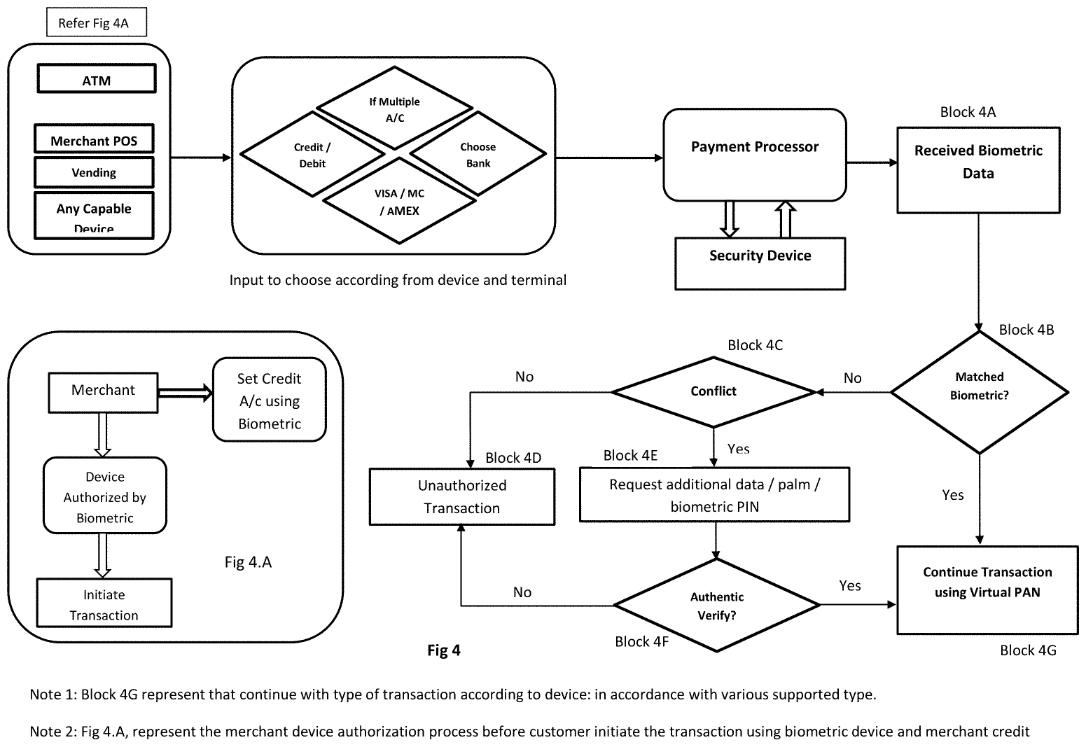

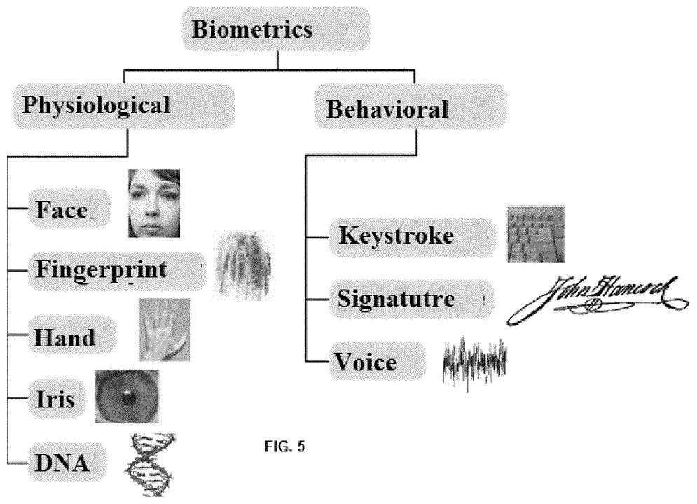

With reference to FIG. 2, a method I (Method J for enrollment using Block 2A and Block 2B) for processing any type of transactions without using debit, credit cards or mobile device or digital wallet is shown, with various embodiments of the invention. The method I may include a control processor device Block 2G in communication with and/or comprising a biometric data device Block 2E. Control processor device Block 2G may generate the cryptogram using key security algorithm Block 2F to encrypt such message data; wherein EPOS, computer (laptop, desktop, notebook or tablet), or a set of computers, ATM, point-of-sale device, any cellular or smart phone, any wearable device, or any other device capable of capturing a biometric data device Block 2E to collect identifying biometric information data to authenticate stored virtual PAN data for customer's account.

With various embodiments of the invention, biometric data device Block 2E may comprise any capable of device by scanning, processing, capturing and/or communicating biometric data or other digital form of biometric data. The biometric data device Block 2E include fingerprint scanner, palm scanner, retinal scanner, touch pad, or other form of biometric data devices capable of capturing behavioural biometric data and/or biometric data. The biometric information captured by biometric data device may be encrypted into message in the form of standard payment message format or other representations at control processor device Block 2G prior to route into bank server or cloud Block 2C over the network. The biometric data prior to route may encrypt the raw biometric data from exposure during communication into network. The processing switch system Block 2H further route the transaction message to bank server Block 2C. Bank server/cloud Block 2C may include one or more devices such as application servers, computers, or other suitable devices.

For larger system, identifying a customer based on Biometrics due to false acceptance rate (FAR) and/or false recognition rate (FRR) being relatively high compared to the number of customers in larger system. In small scale systems potentially having very less number of customers, using biometric identification may be challenging as the FAR and FRR rates virtually guarantee collisions and/or false recognitions when matching a customer to a virtual account. As such case, the customer may choose on the POS the issued account to make payment by using palm scan or entering a biometric password or PIN, which issued for second factor authentication with biometric data. Additionally, encrypted biometric data may be sent in same standard message format to the backend for verification handling by processing switch system Block 2H.

A control processing device Block 2G may be in communication with bank server Block 2C over a payment communication network by using payment processing switch Block 2H. The payment network may be local area network using TCP/IP communication, Wi-Fi, NFC and wide area network in the Internet. The payment communication network may also be an internal network isolated from the Internet. The payment communication networks of method I may be exposed to third party attacks at various points. Control processing device Block 2G and bank server Block 2C may thus communicate over the network with encrypted messages using payment switch system Block 2H. Encryption may be performed by any of the techniques to generate cryptogram message available in the art or which may later available. E.g., available encryption key techniques may include DUKPT, Racal, and RSA, DSA, PKI, GnuPG or other symmetric or asymmetric algorithms but not limited. While message communicates to such level encryption required as TLS/SSL may be used in conjunction with payload encryption to further secure communications.

With various embodiments of the invention, bank server/cloud Block 2C may use the biometric data from a customer account holder in association with a virtual primary account number to access or identify a transaction account associated with the customer account. The virtual PAN may be implying to biometrics such that the virtual PAN is only valid for use with biometric transactions listed herein. Bank server Block 2C may retain a mapping of virtual PANs associated may not be one-to-one. A virtual PAN based on each of fingerprint features or other form of behavioural combination thereof, or a subset multiple virtual for the account associated with the customer's account. Stored biometric data will be associated with accounts by storage in a data store Block 2D specific to virtual issued accounts.

With various embodiments of the invention, the virtual PAN may have any segment, or other limitations as to where and when the virtual PAN may be issued and used. Domain restriction controls may be implemented upon enrollment. While examples of domain restriction controls may include a value limitation of such transactions, and the authentication method, etc. A bank may issue multiple virtual PANs, for example, to merchants to complete a single transaction. A bank may also limit transactions based on virtual PANs to any sort of merchant transaction. The mapping may be stored in an appropriate virtual PAN data store Block 2D using any DB or another suitable database type. Merchants may utilize the virtual PAN to calculate the cryptogram sent to bank servers Block 2C to request authorization. A cryptogram data may include a hash of the biometric data, transaction details, merchant details, date and time of the transaction, a nonce for reply attack prevention), an indicator that this is an physical transaction,” without using card or mobile or digital wallet for the authentication methods.

With various embodiments of the invention, bank server may also use authentication data from the customer's account to identify the transaction which associated with the individual. For example, the captured authentication data may be used to choose input associated with the customer's account from a database.

With reference to FIG. 3, a complete payment transaction diagram, which will be self-guided from the image itself by using various devices and banking system. Merchant initiates transaction for customer using ATM/EFTPOS/POS (FIG. 3, refer no. 1). A biometric payment transaction routes an encrypted message using issuer/acquirer payment processor (FIG. 3, refer no. 2) with the help of global payment gateway standards (FIG. 3, refer no. 3) to process the transaction. The global processor routes acquirer transaction using VISA/MasterCard/Amex/etc (FIG. 3, refer no. 4) to approve/decline transaction by verifying using issuer bank or financial institution. The payment transaction approve/decline message replying to device (FIG. 3, refer no. 5) where the transaction was originally initiated.

The POS may be an existing POS having biometric capture capabilities and updated with software to enable the functionality described herein. Older POS and ATM devices without biometric capture capabilities may also integrate hardware updates and/or replacements to enable biometric capture capabilities.

With reference to FIG. 4A, Merchant will initiate the transaction on the secure Biometric/Merchant device (using the Secured Biometrics Authorization Process) for the customer to make the payment of the goods purchase. Before Merchant initiate the transaction (with Customer's Goods Purchase Amount Details), Merchant will also setup his Credit Settlement Account/Direct Deposit of the goods purchase amount.

Benefit of this invention is to provide the security to avoid the fraud and tempering the device at merchant end.

With reference to FIG. 4, Customer will authorize the transaction by using Merchant Biometric Device (POS, EPOS, Vending Machine or any capable device and ATM) to capture customer Biometric Authorization data and Goods Purchase transaction/any type transactions details with various selection input(s) on devices provided by Merchant/Consumer; A payment processor further route the transaction to bank by using Block 4A to Block 4G methods describe.

According to Block 4A, Bank Server will receive the Biometric data and search the transaction account authorization details. To assess the risk associated with the payment transaction, input data can be identified to a fraud and risk of the payment processor. The bank server will use the Received Biometric Data Block 4A as criteria against the stored biometric data to identify the account (Virtual PAN) and authorization.

With various embodiments of the invention, bank server may enroll customer for Biometric authorization process. Customer Biometric data will be captured and stored in the Bank/Financial Institute server/Cloud Server to issue the account (the Virtual PAN).

Bank server (FIG. 2: Block 2C) may compare the biometric data against the stored Biometric data (FIG. 2: Block 2D) in the Virtual PAN. Stored Biometric Virtual PAN (FIG. 2: Block 2D) may be any digital representation of biometric data in non-image form. For further explanation of security based on fingerprints and gestures see U.S. patent application Ser. No. 14/860,375, entitled “SYSTEMS AND METHODS FOR GESTURE BASED BIOMETRIC SECURITY,” which is incorporated herein in its entirety.

Under the representation of Behavioral and Physiological biometric security features, further explanation of authenticating based on facial recognition see U.S. patent application Ser. No. 14/273,225, entitled “SYSTEMS AND METHODS FOR AUTHENTICATING FACIAL BIOMETRIC DATA AGAINST SECONDARY SOURCES,” which is incorporated herein in its entirety.

With various embodiments, the transaction may also be evaluated on supplementary criteria. This invention payment method only may be restricted to only register Biometric Authorization Process. Customer who has not registered Biometric Authorization Process, are having limitation of the account (Virtual Pan).

During verification/authorization of biometric data conflict against the stored biometric data, as result of the comparison between the received biometric data and the stored biometric data is ambiguous (FIG. 4: Block 4C). In response to a strong likelihood that the biometric data does not match or the risk of the transaction is unacceptable, bank server may decline the transaction (FIG. 4: Block 4D).

In response to an ambiguous result from the comparison, the system may request additional authentication and/or biometric data (FIG. 4: Block 4E). A risky transaction may be characterized by risk markers. Examples of risk markers include, for example, a password entry device without protection or a velocity transaction that seems unlikely such as a user conducting two transactions in a short amount of time on same date between two physical locations that are significantly separated by distance. System may use the additional data to authenticate the individual associated with the transaction account by comparing the additional data to known data associated with the account. System may decline the transaction in response to the step-up authentication failing (FIG. 4: Block 4D). In response to the step-up authentication passing, system may continue the transaction with the account (FIG. 4: Block 4G).

In continuing the transaction with the account, system may apply additional criteria to evaluate risk, account settings, domain restriction controls for biometric payment transactions, or other criteria prior to authorizing a transaction.

With various embodiments, system illustrated as executing on portion of authorization process of transmitted the biometric data to the Bank server in encrypted mode/format. Further validation take place with the decrypted message on various characteristic of a message data.

In event of more than one biometric identifier may be used in order to limit the possibility of false positives allowing for duplicate authentications. For example, the combination of fingerprint from an individual may be used to verify a transaction account belonging to the individual. The biometric data may be supplemented with authentication data such as palm scan and biometric PIN or Password.

System may determine whether the addition data request authorization was successful (FIG. 4: Block 4G). System may decline the transaction in response to the additional verification being unsuccessful (FIG. 4: Block 4E). System may detect unauthorized transaction by evaluating Biometric data unsuccessful by using the received biometric data and/or authentication data as criteria and receiving an empty results set. System may also detect an unsuccessful transaction by submitting a search query using the biometric data and/or authentication data as criteria and receiving a result set having accounts belonging to more than one individual.

During successful authorization, system may determine with various characteristics of the transaction message (which is valid) associated with transaction on the associated account (FIG. 4: Block 4G). The account associated with the biometric data may also include domain restriction controls for the use of the biometric-based payments. For example, the account may include a daily, total, weekly, or other spending limit on biometric-based transactions. The account may also restrict biometric-based transactions to limited merchant segments in case of emergency such as, for example, food, medical, transportation, or lodging.

In response to the transaction being invalid, system may decline the transaction (FIG. 4: Block 4D). In case of security risk measured, system may ask additional data (FIG. 4: Block 4E) as second factor authentication. In response to the transaction characteristics indicating the transaction is valid, system may continue the transaction with the identified account (FIG. 4: Block 4G).

Additional/secondary account holder can be added to the same account by capturing Biometrics measures/data of the secondary account holder and stored/map along with Primary account holder's biometric data. This will enable both, primary and secondary account holders can perform the payment transaction for the same account using the biometric payment method solution.

Customer account details and/or other biometric data can be stored in the database. Merchant can be authorized biometric device by using his/her biometric data or else by using biometric PIN or password.

Any databases discussed herein may include relational, hierarchical, graphical, block chain, object-oriented structure and/or any other database configurations. Any database can be used to implement this invention/solution.

With various embodiments of this invention, methods can be described herein may be vulnerable to attacks including spoofing, tampering, repudiation, information disclosure, denial of service, and escalation of privilege. Any type of biometric terminals may not be under the control of customers and may be rogue terminals. However biometric terminal device can be authorized before initiating the transaction with additional security of biometric merchant authentication method.

The disclosure and claims in this invention specification can be developed using any combination of rules and various embodiments with specific rules, technologies and programing languages.

Moreover, the claimed invention includes an inventive concept that may be found in the non-conventional and non-generic arrangement of known, conventional pieces and our invention method go way beyond any conventionality of any one of the systems in that the interaction and synergy of the systems leads to additional functionality that is not provided by any one of the systems operating independently.

The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the method/process may include alerting a subscriber that may include generating customized information and alerting to the subscriber's wireless devices or any other electronic devices by SMS, email or any alert massage standard. Alert message may contain characteristics of transaction details.

With various embodiments of this invention, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

With various embodiments of this invention, merchant biometric system can configured and accessible using any computer device to add/remove third party authorised person with restricted role based access to handle the merchant biometric device.

Innovation system, methods and computer program products are provided. In the detailed description herein, references to “various embodiments”, “With various embodiments of this invention”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post; social network input and/or any other method known in the art.

Phrases and terms similar to “transaction account” or “Virtual PAN (Primary Account Number)” may include any account that may be used to facilitate a financial transaction.

Phrases and terms similar to “financial institution” or “bank” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

The phrases consumer, merchant, customer, user, account holder, account affiliate, card member or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the card member may include a transaction account owner, a transaction account user, an account affiliate, a child account user, a subsidiary account user, a beneficiary of an account, a custodian of an account, and/or any other person or entity affiliated or associated with a transaction account.

With various embodiments of this invention, any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. Moreover, examples of mobile device communications include texting, email, and mobile applications for smartphones.

A “consumer profile” or “merchant profile” or “consumer profile data” or “merchant profile data” may comprise any information or data about a consumer/merchant that describes an attribute associated with the consumer/merchant (e.g., a preference, an interest, demographic information, personally identifying information, and the like).

With various embodiments of this invention, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; biometric data; merchant data; financial institution data; and/or like data useful in the operation of the system. Various operating system can be used to develop and maintain this invention/solution.

With various embodiments of this invention, the present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices. The computer system includes one or more processors, such as processor. The processor is connected to a communication infrastructure that may include various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

With various embodiments of this invention, “Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

With various embodiments of this invention, one skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like. Similarly, the software elements of the system may be implemented with any programming or scripting languages.

What is claimed:

1. A method for settlement of a payment transaction without using any type(s) of cards or mobile devices, comprising of:
a. enrolling one time biometric information while opening of an account to any Bank or Financial Institution or any financial services;
b. capturing and storing the biometric data using any capable device including all finger(s) and both the palms while registering with a secured issuing bank server or cloud server of the financial institution;
c. representing the biometric data—L as Left hand, R as Right hand; and, further identifying by L1—baby finger, L2, L3, L4, L5—left thumb and R6—right thumb, R7, R8, R9, R10—baby finger;
d. issuing a virtual Personal Account Number/account to customer upon completion of account opening process by storing biometric data;
e. initiating any type(s) of transaction using capable biometric device for capturing biometric information without physical card;
f. providing such on-pad input instructions to guide a customer by selecting various inputs like any type of credit/debit, local/foreign, banks, standards for identifying the issuer bank or financial institution identification number associated with the customer to route transaction;
g. guiding a customer to capture the biometric data for requested finger(s) by using random generation algorithm at the time of transaction initiation by the merchant;
h. capturing the biometric data for requested finger(s) are in a combination of single, 2, 3 or more finger-prints;
i. encrypting a customer's biometric input data from ATM/POS/any form of capable device by using security device under secured algorithm;
j. considering a virtual PAN, Personal Account Number, has restriction against the transaction date & time, amount and merchant details in the biometric message captured by using the secured device;
k. routing a standard cryptogram payment message with identification of finger(s) for verification;
l. verifying the biometric input data details, contains identification of finger(s) by bank or financial institution to identify and authenticate against stored identification biometric data;
m. authorizing the captured biometric transaction message by the bank or financial institution or cloud server(s) associated with virtual PAN or virtual credit card account;
n. sending an approval reply upon a successful biometric authorization or finger(s) scan match against stored biometric data, as successful transaction confirmation;
o. un-authorizing or declining a transaction when finger(s) scan match not found; and, sending an unsuccessful transaction message response by using the standard(s) messaging information.

2. A method of claim 1, wherein the identity of finger(s) instructed to the customer using a random generation algorithm from the device.

3. A method of claim 2, further comprising of:
a. sending an authorization request message to the bank or financial institution server for verification;
b. describing a standard payment cryptogram message including characteristics of the payment message with identification of the finger(s);
c. authorizing the payment by replying standard message communication methods associated on the Virtual PAN.

4. A method of claim 3, further comprising of:
a. determining at the time of encountering unauthorized/declined transaction based on security risk;
b. including at least one of a second factor authentication will be requested for authorization;
c. providing palm scan or biometric virtual PAN password/PIN without protection which is associated and registered;
d. identifying a risk transaction in which the customer initiates two transactions;
e. using a difference amount of time on same date at two physical locations that are significantly separated using merchant and device registered information.

5. A method of claim 4, further determining a standard payment cryptogram message, differentiates from the captured biometric information associated with stored biometric behavioral information to decline by such response in the reply message.

6. A method of claim 1, further comprising of:
a. conducting any type(s) of transaction by the bank or financial institution branch using a similar point of sale device and credit against other party;
b. including any type(s) of transactions (point of sale, rewards, loyalty points, branch transfers or ATM) on any type(s) of device not limited to and allows under the feature of this invention.

7. A system comprising:
a. a biometric device, enrolling at the bank or financial institution while registering with bank and issuing a virtual PAN upon completion of account opening process;
b. a biometric information storage device, by the secured issuing bank server or cloud server of the financial institution, storing biometric data including all finger(s) and both the palms;
c. an EPOS system, or point of sale, or ATM device, or any such capable of devices or processor configured to further communicating with payment switch or similar process system;
d. a reader device connected to payment network providing on-pad input instructions to guide customer by selecting various inputs like any type of credit/debit, local/foreign, banks, standards to route transaction by identifying the issuer bank/financial institution associated with the customer;
e. a biometric ATM/POS/any form of capable device, capturing biometric data at the time of transaction initiation by the merchant;
f. a security device under secured algorithm, encrypting customer's biometric input data for the requested finger(s) by using random generation algorithm;
g. a payment processor, routing a standard cryptogram payment message with identification of finger(s) for verification;
h. a bank or financial institution server, approving or declining a payment settlement transaction or point of sale transaction based on stored biometric information verification.

8. A system of claim 7, wherein:
a. a payment cryptogram including characteristics of the standard transaction message protocols and issued against virtual PAN information;
b. encrypting and decrypting of information by using standard algorithm(s) where it is required.
